(19) United States
(12) Patent Application Publication
(10) Pub. No.: US 2003/0023610 A1
(43) Pub. Date: Jan. 30, 2003

(54) Online real and personal property management system and method

(76) Inventors: Stephen B. Bove, Westlake Village, CA (US); Mark N. Cohen, Thousand Oaks, CA (US); Matthew L. Cohen, Woodland Hills, CA (US); Bruce J. Cornelius, Westlake Village, CA (US); Edward A. Engman JR., Houston, TX (US); Jonathan A. Greenblatt, Santa Monica, CA (US); Russell A. Mann, Thousand Oaks, CA (US); Peter B. Tafeen, Agoura Hills, CA (US); Stuart Wolff, Westlake Village, CA (US)

Correspondence Address: BROWN RAYSMAN MILLSTEIN FELDER & STEINER LLP, 900 THIRD AVENUE, NEW YORK, NY, 10022, US

(21) Appl. No.: 09/915,456

(22) Filed: Jul. 27, 2001

(51) Int. Cl. G06F 7/00

(52) U.S. Cl. 707/101

(57) ABSTRACT

A property management system and method is disclosed. The system comprises a database and a first one or more data records stored in the database. The first one or more data records are for storing data unique to a first property. The data unique to the first property is capable of being used for managing the first property. A second one or more data records are stored in the database. The second one or more data records are for storing data unique to a first owner of the first property. The data unique to the first owner is capable of being used for the first owner's management of the first property in combination with the data unique to the first property. A database management system is adapted to parse the first one or more data records for use by a second owner of the first property after the first property is conveyed from the first owner. The database management system is further adapted to parse the second one or more data records for retention by the first owner for use by the first owner in management of a second property.

### BACKGROUND OF THE INVENTION

1. Field of the Invention

The invention is a property management system and method. Specifically, the invention aids in the management of real and personal property by allowing detailed information related to any property to be entered and used for the managing of real and personal property. Upon sale of a property, users of the system may be able to merge specific information with property owner specific information, wherein the information can be parsed if the property is conveyed.

2. Description of the Prior Art and Related Information

Managing property, whether real or personal, can be a challenge. Especially properties that contain complex machinery or that require special care. For example, large homes sometimes have multiple climate control units and diverse appliances. These diverse machinery and appliances can be difficult to maintain given different maintenance schedules and special handling instructions. Heretofore property owners have been required to keep their own maintenance calendars for each appliance or machine. Owners' manuals, warranty information, and other detailed information on these appliances and other systems within the home are often not available or incomplete. Further, tools to manage the financial data related to the home to track equity, valuation, tax liabilities, and the like, may be complicated and difficult to use in personal and asset management.

The management of real property is especially difficult in light of the mobile nature of today's society. This is especially true given that a typical person will move several times over his or her lifetime. In addition, several different individuals will typically own the same home throughout its lifecycle. Trying to pass information relating to a particular property between succeeding owners of the property may often be disjointed. For example, homeowners may lose documents or papers containing important information related to their home as a result of carelessness. Information, such as those relating to owners' manual and warranty of appliances, house dimensions, fumigation records, and the like, may get lost over the years. Thus, succeeding owners or even the original owners may have difficulty locating this type of information when it is time to sell the property. Further, potential buyers may be reluctant to purchase the property because they are unable to obtain relevant information in a timely manner. Of course, such problems are not restricted to only real property but may also apply to personal property, for example, automobiles.

When a property is conveyed, the new property owner must rely on the selling owner to give the new property owner all of the information and maintenance schedules unique to the property needed to manage and maintain the property. As described above, often the departing owner will not have accurate and/or complete records and complete records may not be conveyed to the new property owner.

There are other situations where it would be highly desirable for other third parties to have access to particular information relating to a property. For example, when a property owner decides to sell a property, the sale of the property may be hampered if the seller's agent is unable to obtain important information relating to the property in a timely manner. Ideally it would be preferable for the seller's agent to have timely access to certain information relating to the property such as the dimensions of the property, photos of the property and warranty information related to the property.

Some property owners have personal preferences for particular service professionals and a need to track details related to (but not part of the infrastructure) of the home. They may also have personal preferences for how often some maintenance tasks are carried out, a need to track maintenance schedules and details of repair work completed. All of this information is hard to track and is unique to the property owner. Further, information unique to the owner can be difficult to coordinate with the maintenance information unique to a property, especially when the owner moves to a new property and must become familiar with maintenance for the new property.

In addition, managing one's personal affairs in today's hectic world is becoming increasingly difficult. This is especially true when one takes into consideration that each person and/or family is committed to a number of activities and obligation on any given day. Trying to coordinate all the commitments and all the activities while tracking and maintaining important information related to a person's personal affairs as well as his or her personal assets may become overwhelming.

### SUMMARY OF THE INVENTION

A property management system and method that solves the above-cited problems is disclosed and claimed herein. The system comprises of one or more databases that may be spread across multiple servers and/or web sites.

The database or databases stores a plurality of data records. Each record may be related to a particular property and/or an owner of the property. For example, data records comprising of information related to a particular real estate property may make up one or more data records. While another one or more data records may comprise of information related to the owner of the real estate property. Each one or more data records may be parsed and integrated with other one or more data records. Further, access to each one or more data records may be restricted or may be made available to different individuals or entities.

The database just described may be best illustrated by the following example. A database may comprise of a first one or more data records stored in the database. The first one or more data records may be for storing data unique to a first property. The data unique to the first property may be used for managing the first property. This may include details about the home (measurements, materials, plans, photos, and the like.), it's service history, professionals that have worked on the home, product and warranty information for items that are part of the home, the home's price history, and the like. Also, financial information related to the property may also be included in the first one or more data records. For example, information related to tracking home valuation, home equity, impact of home projects to valuation and taxes, tracking cost of home related expenses to identify cost basis for home, and time to end PMI insurance are all valuable information useful for managing and tracking of real.

A second one or more data records may be stored in the database. The second one or more data records are for storing data unique to a first owner of the first property. The data unique to the first owner is capable of being used for the first owner's management of the first property in combination with the data unique to the first property. In addition, information stored in the second one or more data records may include detailed information about items owned within the home (for product, warranty, or insurance records), financial records tied to the investment and equity in the home, contacts, project information, and the like. Further, personal information relating to the first owner, for example, appointments, tax information, birthdays, reminders, and the like, may also be stored in the second one or more data records. Finally, information related to the personal affairs of the owner may also be included in the second one or more data.

A database management system (DBMS) is adapted to parse the first one or more data records for use by a second owner of the first property after the first property is conveyed from the first owner. The DBMS may be further adapted to parse the second one or more data records for retention by the first owner for use by the first owner in management of a second property. The DBMS may be adapted so that the first owner may choose to share some or all the information contained in the second one or more data records with a succeeding owner of the property and/or others anytime before and/or after the first property is conveyed to the succeeding owner.

The DBMS may further be adapted for integrating the second one or more data records with a third one or more data records after the first owner is conveyed a second property. The third one or more data records may be for storing data unique to the second property. The data unique to the second property may be used for managing the second property in combination with the second one or more data records (i.e., the data record set which comprises of information related to first owner as it related to the first property).

The DBMS may be adapted for populating the first one or more data records by receiving at least a portion of the data unique to the first property from a multiple listing service. The database management system may receive the portion after the address of the first property is matched with corresponding data in the multiple listing service. Information within this property management system may also come from users self entry, records from the homebuilder, home inspection records, transaction records or other source of data identified or provided by the system provider to aid in the pre-population of data. Although the above example was limited to real estate transactions, those skilled in the art will recognize that the features of the present invention may be applicable to personal property such as automobiles and appliances.

### BRIEF DESCRIPTION OF THE DRAWINGS

The components in the figures are not necessarily to scale, emphasis instead being placed upon illustrating the principles of the invention. Moreover, in the figures, like reference numerals designate corresponding parts throughout the different views.

FIG. 1 is a block diagram illustrating a property management system according to one embodiment of the present invention;

FIG. 2 is a flow diagram illustrating the steps in a method performed in the system of FIG. 1; and

FIG. 3 is a partial database structure for a database of the system of FIG. 1.

### DETAILED DESCRIPTION OF THE PREFERRED EMBODIMENTS

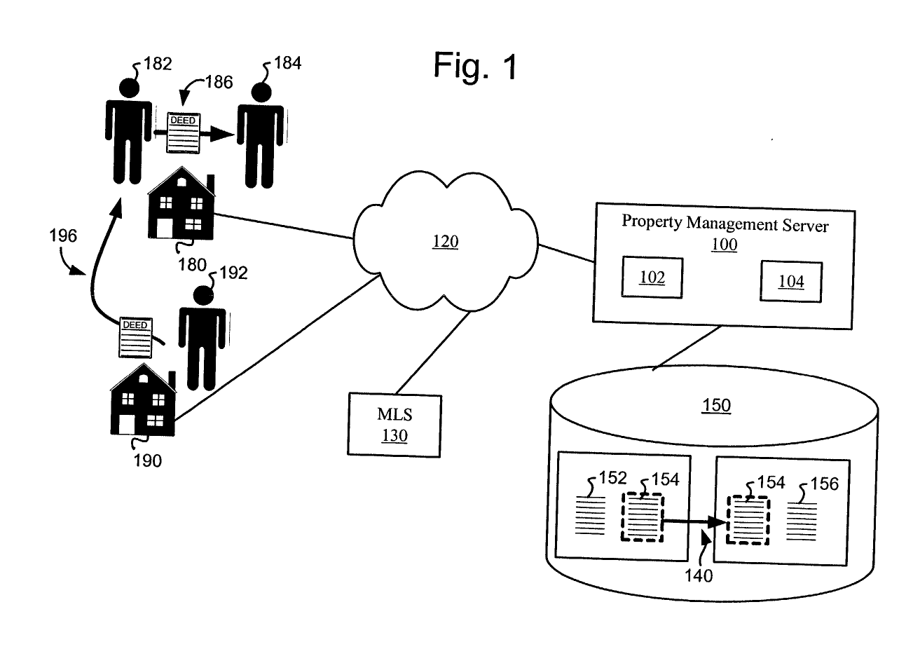

FIG. 1 is a block diagram illustrating a property management system according to one embodiment of the present invention. The system includes a server 100, which may comprise a standard reduced instruction set chip (RISC) or complex instruction set chip (CISC) processor 102 running the NT operating system by the Microsoft Corp. of Redmond, Wash., or a suitable UNIX server such as an ENTERPRISE Server by Sun Microsystems of Palo Alto, Calif., or an AS400 System by the IBM Corporation, USA.

The server 100 includes a database management system (DBMS) 104, which may comprise of one or more modules. For example, the DBMS 104 may comprise of a module for parsing data records in a database 150, for monitoring an MLS 130, for integrating data records, tracking data records, updating data records, transferring data records, monitoring advertisements, and providing a calendar system for keeping track of relevant dates and to use in combination with other features of the system to generating notices when those dates and/or milestones are reached. The roles that these modules play in this system will become clear in the example provided below.

The server 100 may be accessed in a number of ways. For example, homeowners may access the server through a network 120 using a PC, a telephone, a wireless device, or other equivalent means. The server 100 may include a database 150. Although in this embodiment, the system is shown to have a single server 100 with a single database 150, the present invention is not restricted to a system with a single server 100 and a single database 150. Rather, the present invention allows for systems with multiple servers 100 and multiple databases 150 located at multiple sites.

The database 150 may be relational, object oriented, or otherwise, and may work as part of a relational database management system (RDBMS) such as ORACLE8i Release 2 by Oracle Corp. of Redwood Shores, Calif. or MICROSOFT SQL SERVER by The Microsoft Corp. of Bellevue, Wash., which may be stored on a magnetic media, such as a hard disk drive, or optical storage, which may be either internal or external to the server 100.

For illustrative purposes, the database 150 of FIG. 1 is shown comprising of one or more data records 152, 154, 156. The database (or databases) 150 stores a plurality of data records. Each record may be grouped together with other data records to form a one or more data records 152, 154, 156. Thus, each one or more data records 152, 154, 156 may contain one or more data records. Each one or more data records 152, 154, 156 may generally be related to, for example, a particular person or property. For example, a one or more data records may comprise of data unique to a particular real estate property such as valuation records, house dimensions, house maintenance records, property tax, and the like. Meanwhile, another one or more data records may contain data unique to the owner of the real estate property such as mortgage information, utility expenditure records, personal preferences, appointments, personal tax information, and the like. Each one or more data records may be parsed and/or integrated with other one or more data records. Further, access to each data records may be made available to selected individuals or entities.

Each record may be “populated” using different sources. That is, the information contained in each record may be obtained by various sources at various times. For example, the system may obtain information from sources such as Multiple List Services (MLS), user self entry, records from homebuilders, home inspection records, transaction records or other sources of data identified or provided by the system provider. The data record may initially be pre-populated using information already available from these sources or may be pre-populated with already existing information in the database.

The system according to the present invention may store a wide range of information unique to both owners of properties and to specific properties. As stated earlier, information unique to a real property, for example, maintenance records, information related to service providers such as plumbers and electricians, mortgage and equity information, tax information and records, property valuation and appraisal information, homeowners and PMI insurance information, and the like, may be stored. Information unique to the owner of the real property may also be stored. For example, personal preferences as to which plumbers or electricians are preferred or monthly utility bills may be stored. In addition, information unique to owners of personal property (e.g., refrigerators) such as owners manual, warranty information, maintenance records, service provider information, and the like, may be stored in the system. Further, information related to the personal affairs of property owners may be stored. For example, the daily appointments of the owner and/or important events such as birthdays and anniversaries may be stored. Statistical data may also be kept in this system and may be accessed by selected individuals and entities. In addition to storing a wide range of information, the system allows for the parsing and integrating of this information providing notice and record keeping functionality for property owners.

The present invention allows certain stored information to be accessed by selected individuals and/or entities. For example, homeowners may want their real estate agent (i.e., seller's agent) to be able to access some of the information stored in the database 150 to facilitate selling activities. The database 150 may contain important information that would help the real estate agents in selling the home. For example, photos of the home, the dimensions of the home, monthly utility costs, and the like, are the types of information that could be very helpful to the real estate agent. The agent may therefore have access to certain information contained in the data records 152, 154, 156.

The information stored in the database 150 may be processed by the property management server 100 and used for a variety of purposes. For example, the property management server 100 may use the information stored in the database 150 for target advertising. Selected advertisements may be channeled to particular homeowners depending upon the preferences of the homeowners and the characteristics of the home. The property management server 100 monitors' advertisements and the information stored in its database and compares the information related to a particular homeowner with the advertisements. When it is determined that a particular advertisement is appropriate for a particular homeowner, the server 100 may notify the appropriate homeowner by, for example, e-mail or voice mail.

The property management server 100 may provide tracking capabilities for home equity, home valuation and private mortgage insurance (PMI). With a home equity tracker, a homeowner may track the equity he has in his home by first obtaining comparative sales figures from sales of comparable homes in the same neighborhood sales. Then using those figures together with the details of the mortgage (data of purchase, down payment, and interest rate) determine equity. Information related to comparative sales of homes in the same neighborhood can be obtained from the MLS and/or from other databases. The results of the equity tracker may be presented in a visual display showing the amount of equity in the home. Also, when key milestones are reached, e-mail or other equivalent means of notification may be given to the homeowner. Key milestones that the system may check for include, for example, the amount of equity to borrow against for a pre-defined project, or for the purchase of a new home.

With a home valuation tracker, the value of a homeowner's home may be calculated by various means including the use of comparative sales figures. Results of such analysis may be provided by, for example, a visual chart (similar to a stock chart) that shows the movement in home valuation. This can be accessed graphically through a choice of time periods, and comparisons to other areas. E-mail or other equivalent means of notification such as voice mail may alert the homeowner when the price of the home has reached a certain price or percentage of movement in value.

With a PMI tracker, a homeowner may track the status of his PMI in relation to equity. That is, the system calculates the home's equity in relation to PMI and may provide an alert when the PMI may be cancelled. Again, the status of the PMI may be presented in a visual display. If a milestone is reached, email or other equivalent means of notification may alert the homeowner that the milestone has been attained.

The various features of the present invention may be best illustrated by the following example together with FIG. 1. In this example, a first one or more data records 152 is used for storing data unique to a first property 180. The data in the data records 152 is unique to the first property 180 and may be used for managing the first property 180. The first one or more data records 152 may include data, for example, regarding the type of piping used in the first property 180 when a structure on that property 180 was built. Other types of data that may be included include data relating to how often the air conditioner should be flushed, fumigation records, house dimensions, and the like.

A second one or more data records 154 is stored in the database 150. The second one or more data records 154 may be for storing data unique to a first owner 182 of the first property 180. The data stored in the second one or more data records 154, unique to the first owner 182, may be used for the first owner's management of the first property 180 in combination with the data unique to the first property 180 stored in the first one or more data records 152. An example of the type of data stored in the second one or more data records 154 include data relating to the first owner's preference for air conditioner service professionals. Such information may be used to provide notice to homeowners when milestones have been reached. Other examples of data that may be stored in the second one or more data records 154 include grocery delivery lists and times for delivery, exercise schedule, school schedule, automobile upkeep data, and the like.

In this example, the data relating to how often the air conditioner should be flushed in the first one or more data records 154 may be used by the server 100 to determine if it is time to have the air conditioning system flushed on the first property 180. Calendar software running on the server 100 may be programmed to send an electronic mail message, fax, or voice mail message to the first owner 182 reminding the first owner 182 that it is time to have the air conditioning system flushed. The system may also automatically send an electronic mail, fax, or voice mail message to the first owner's preferred air conditioner service professionals as read from the second one or more data records 154 so that they may contact the first owner 182 to schedule a time to flush the air conditioner. Alternatively, the server 100 may be programmed so that when it is determined that it is time to flush the air conditioning system, the server 100 automatically sends a message by email or other equivalent means to a number of service providers soliciting bids from the providers. The interaction between the first one or more data records 152 and the second one or more data records is one feature of the system. An example of this interaction was introduced above and will be explained in greater detail below. Continuing on with our example, the calendaring system in the server 100 reads both the schedule for air conditioning flushing from the first one or more data records 152 and the preferred air conditioner service professionals data from the second one or more data records 154. The system then produces notifications to the first owner 182 and to the preferred air conditioner service professional based on the combination of the first and second one or more data records 152, 154.

For many homeowners, the biggest asset in their investment portfolio is their homes. Consequently, during ownership of a particular property, an owner would typically prefer to keep an accurate record of the property. The first owner 182 may want to track the home equity, home valuation and the status of PMI during his ownership of the first property 180. The property management server 100 may accomplish these tasks by monitoring comparatives sales of comparable homes in the neighborhood (which is typically available on-line), the original mortgage data stored in the database 150, self-entries by the first owner 182 and any other information that may be stored or available to the server 100. Further, the property management server 100 may parse and integrate the information stored in the various one or more data records to provide analytical results. The results of the parsing and integrating capabilities of the server may be displayed on a PC that may provide a visual chart (similar to a stock chart) and/or notification by, for example, e-mail or voice message.

The first owner 182 may provide access to some or all of the information contained in both the first and/or second one or more data records to the MLS, real estate agents or any other interested parties when he is ready to sell the first property 180. Of course, the first owner does not have to wait until he is ready to sell the property before he allows others access to information contained in the first and/or second one or more data records. By allowing the MLS, real estate agents and other interested parties access to relevant information relating to the first property 180, the selling of the first property 180 may be better facilitated. This allows potential buyers to have access to important information that the potential buyer may need in deciding whether to purchase that property.

When the first property 180 is actually conveyed to a second owner 184 in a property transaction as generally indicated at 186 in FIG. 1, the database management system (DBMS) 104 may parse the first one or more data records 152 for use by the second owner 184 of the first property 180 after the first property 180 is conveyed from the first owner 182. In addition, the first owner may choose to share some of the information contained in the second one or more data records 154 with the second owner 184 which may help the second owner 184 better manage his just acquired property. For example, the second one or more data records 154 may contain information that may be of use to the second owner 184 such as what the first owner 182 spent on monthly utilities or the first owner's preferences for plumbing services.

After conveying the first property 180 to the second owner 184, the first owner 182 may purchase a second property 180 from a third owner 192 in a property transaction generally indicated at 196. The database management system 104 is further adapted to parse the second one or more data records 154 for retention by the first owner 182 for use by the first owner 182 for managing the second property 190. The second property 190 may be associated with a third one or more data records 156. The database management system 104 integrates the second one or more data records 154 with a third one or more data records 156 (as generally indicated at 140) after the first owner 182 is conveyed the second property 190. Similar to the first one or more data records 152 with respect to the first property 180, the third one or more data records 156 are for storing data unique to the second property 190. The data unique to the second property 190 is capable of being used for managing the second property 190 in combination with the second one or more data records 154. Once the second and third one or more data records 154, 156 are integrated, the second and third one or more data records 154, 156 interact similarly to the interaction between the first and second one or more data records 152, 154 that occurred when the first owner 182 owned and managed the first property 180.

The server 100 may be accessible from the owner's home computer through dial up, ISDN or T1 connections, or the like, through a network 120 such as the Internet. An owner 182, 184 or 190 may access the server 100 in order to check on upcoming maintenance for the property 180, 190, or to initially set up the property 180, 190 in the database 150. In addition, various other entities may be connected to the Internet and may exchange information with the server. For example, multiple listing service (MLS), builders, inspectors, government agencies, providers of transactional documents such as banks, and other databases storing records may be connected to the network and may exchange information with the server 100.

The MLS together with databases that are connected to the network 120 may exchange information with the property management system 100 that may be of interest to both owners of properties and potential buyers of properties. For example, one way for an owner to set up a record for a property 180, 190 in the database 150 is to initially pull data from a MLS 130 connected to the network 120. The MLS 130 may contain a wealth of information regarding the property 180, 190 that may aid in the maintenance of the property 180, 190.

A property 180, 190 for sale is commonly offered through a real estate agent. A real estate agent typically maintains a listing of properties offered through the agent's office, or through the company that the agent is associated with. In order to more effectively market that property to interested buyers, real estate agents typically furnish their listings to the multiple listing service 130. The MLS 130 accepts listings from a number of different agents and real estate sales companies for properties 180, 190 offered for sale in a given geographic area. The MLS 130 then places those listings into a MLS database that can be searched by agents or potential buyers.

To facilitate the entry of data into the MLS database, real estate agents are typically presented with a form having a number of discrete data requests corresponding to specific features of the property. Such a form generally requests items such as the number of bedrooms and bathrooms. The form may also present a number of selections regarding the presence or absence of various amenities of the listed property. For example, a selection to indicate whether there is a pool or deck on the property. Once the form is completed, the data is encoded into the MLS database. Interested buyers and their agents may thus search the MLS database for properties 180, 190 having one or more particular characteristics.

The MLS data can be used to populate the first or third one or more data records 152, 156 because the various features of the first or second properties 180, 190 may be important in determining property management needs for the first, second, or third owners 182, 184 and 192. The ability to populate the first and/or third one or more data records 152, 156 using the MLS data may add value to the property because potential buyers of the property will have readily accessible information related to that property. Thus, homeowners will likely have an incentive to list information related to their property in the MLS database. A more comprehensive explanation of multiple listing services (MLS), and a method and system for aggregating and standardizing real estate data from multiple listing services provided in diverse formats can be found in U.S. application Ser. No. 09/705,418 filed Nov. 2, 2000, entitled “Method For Standardizing Real Estate Data In Diverse Formats” which hereby is incorporated by reference in its entirety.

When a property owner 182, 184, 192 requests that the server 100 initialize the property 180, 190, the DBMS 104 may populate the first one or more data records 152, 156 by receiving at least a portion of the data unique to the property 180, 190 from the MLS 130. The server 100 may also check other databases that may have information useful for populating the first one or more data records 152, 156. After being conveyed a property 180, 190, the owner 182, 184, 192 may enter the address of the property 180, 190 on a terminal that is in communication with the server 100. The server 100 first checks the database 150 for whether the property 180, 190 has already been entered into the system. If not, then the server 100 logs on to the MLS 130. Then the address of the property 180, 190 is matched with corresponding data in the MLS 130. If the owner 182, 184, 182 knows the MLS identification number of the property 180, 190, the server may alternatively receive that number during initialization, and use it to match the property 180, 190 in the MLS 130. Of course, knowledge or having a MLS identification numbering system is not a necessary requirement in identifying properties. Properties may also be identified by its known street address or by any number of other means of locating such a property, such as for example, using city zoning lot numbers for identifying and locating properties. In any event, the corresponding data is then downloaded into the one or more first and/or third data records 154, 156 for integration with the second one or more data records 154.

The property management server 100 may match and compare the information it has stored in its database 150 for a particular property and compare it to the information for the same property stored in the MLS database. Since not all property management servers may have access to MLS property identification numbering systems, the key identifier for a particular property will preferably be the street address of the property. If, after comparing the information provided by the MLS and the information stored in its database 150, the property management server 100 finds that there is a need to update the information in its database, then the corresponding data may be downloaded into the one or more first or third data records 154, 156. The property management server 100 may then integrate the updated the one or more first or third data records 154, 156 the second one or more data records 154.

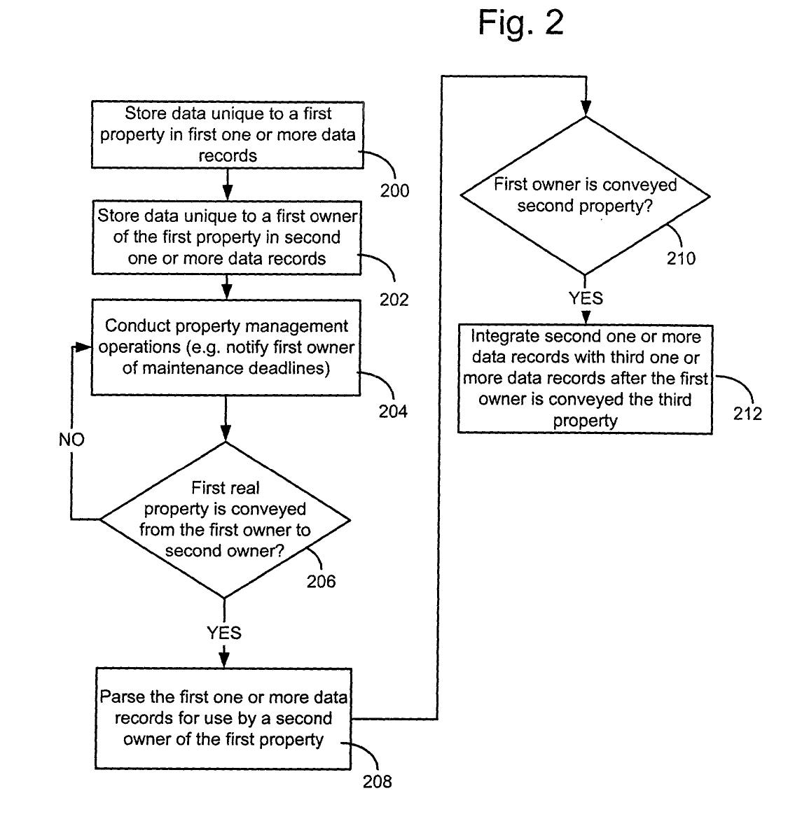

With reference to FIG. 2, a flow diagram illustrating a method performed by the system of FIG. 1 for managing property is shown. The server 100 stores data unique to a first property in the first one or more data records 152 in the database 150, step 200. Step 200 may be accomplished by populating the first one or more data records 152 by receiving at least a portion of the data unique to the first property 180 from a MLS 130. The data unique to a first owner 182 of the first properly 180 is stored in a second one or more data records 154 in the database 150, step 202. The first owner 182 may accomplish this task, for example, by inputting the data himself through a computer terminal and/or transferring information already stored in the database 130 or other databases that may be connected to the network 120.

Once the first and second one or more records 152, 154 are stored in the database 150, they can be integrated and used to provide management information to the first owner 182 as described in the examples described earlier, step 204.

If the first owner 182 decides to convey the first property 180 to the second owner 184 (shown generally at 186 in FIG. 1), step 206, the processor 102 and DBMS 104 parses the first one or more data records 152 for use by the second owner 184 of the first property 180 after the first property 180 is conveyed from the first owner 182.

The first owner 182 may purchase a second property 190. When the first owner 182 moves from the first property 180 to the second property 190, the processor 102 and DBMS 104 parses the second one or more data records 154 for retention by the first owner 182 for use by the first owner 182 for managing the second property 190, step 208. Retention of the second one or more data records 154 may mean that the first owner 182 is provided with a removable storage media such as a floppy disk or compact disk containing the second one or more data records 154. Alternatively, the server 100 keeps the second one or more data records 154 in a temporary storage area in the database 150 until the first owner 182 needs them.

Once the first owner 154 is conveyed the second property 190, step 210, the processor 102 and DBMS 104 integrate the second one or more data records 154 with a third one or more data records 156, step 212. The second and third one or more data records 154, 156, in combination, can be used to manage the second property 190.

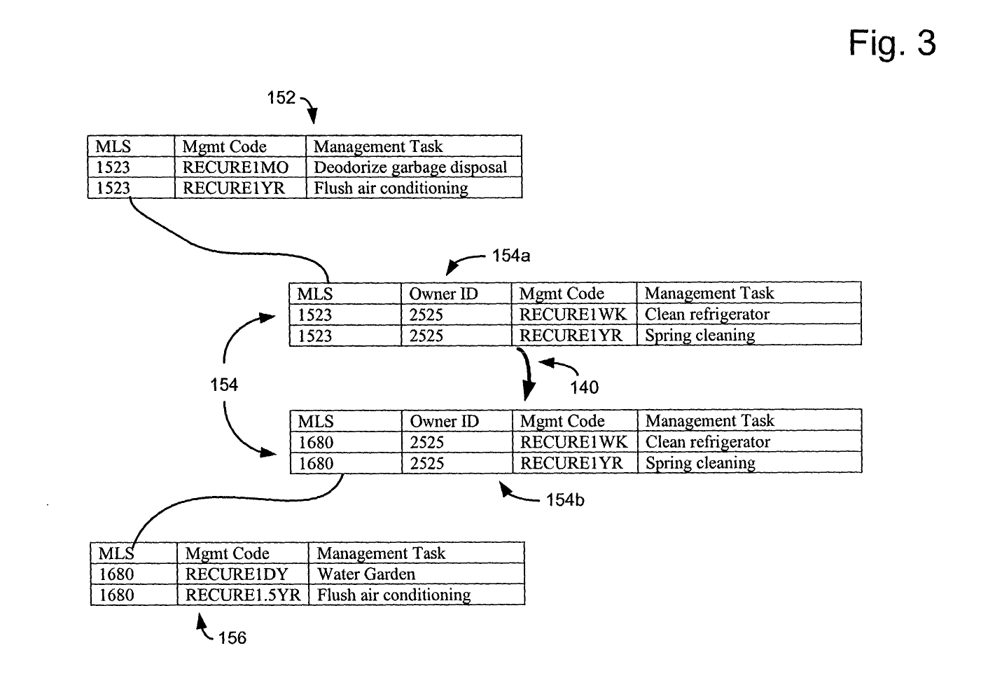

Integrating the owner's property management data, e.g. the second one or more data records 154, with the property specific property management data, e.g. the first or third one or more data records 152, 156, may be accomplished by standard database record indexing and manipulation techniques. With reference to FIG. 3, an illustration of how the transaction indicated at 140 in FIG. 1, and explained as steps 208 and 212 in FIG. 2, is shown. The first one or more data records 152 may comprise a master table having three fields, a MLS field, Mgmt Code field, and a Management Task field. The MLS field is a key field containing the MLS number for the first property 180. The Mgmt Code field may comprise a transaction code for a property management task indicating, for example, whether the task is recurring and how often. The Management Task field may indicate, and describe the task to be performed. These fields are not exhaustive, and many other fields may be included. For example, a sequence field sequencing the records may be desired.

The second one or more data records 154 similarly may be a database table with an MLS field contained therein. The state of the second one or more data records 154 before conveyance is illustrated as indicated at 154a. The MLS field in the second one or more data records 154 is a key field that links the second one or more data records 154a to the first one or more data records 152. The second one or more data records 154a include an Owner ID field that indicates that the first owner 182 is the owner of the first property 180 before the conveyance. The second one or more data records 154a also each contain a Mgmt Code field and a Management Task field like that of the first one or more data records 152. The Mgmt Code field and the Management Task field contain data unique to the first owner 182 for use for managing the particular property that the first owner 182 owns.

When the first owner 182 logs on to the server 100 and indicates that the first property 180 has been conveyed, and that the first owner 182 has been conveyed the second property 190, a transaction indicated at 140, the system receives data unique to the second property 190 from the first owner 182 either by receiving the data from the first owner's terminal or from the second owner 192 and/or from the MLS 130(see FIG. 1). At least a portion of the data unique to the second property 190 may be received from the MLS 130, either by matching the address of the second property 190 to data in the MLS 130, or by receiving the MLS identification code from the first owner 182 and matching it in the MLS 130. The data unique to the second property is stored in the third one or more data records 156, which may comprise a table in, database 150. The second one or more data records 154a are modified to reflect the transaction 140 by changing the MLS field to match the MLS code in the third one or more data records 156 as indicated at 154b. The second one or more data records 154b would then by linked by the MLS field to the third one or more data records 156.

The present invention also provides a system and method for managing a person's personal affairs. For example, the second one or more data records 154 may store information related to a homeowner's appointment book. The server 104 may continuously monitor the contents of the second one or more data records 154 and may provide reminders to the homeowner via e-mail, telephone, wireless devices, and the like, of a upcoming event or appointment.

Although the example provided above discussed the use of the present invention as applied to real properties (e.g., house, apartment, condominiums, and the like), the system may be equally applicable to personal property (e.g., personal computers, refrigerators, cars, and the like). For example, the first owner 182 may own an automobile that he purchased on credit. The first one or more data records 152 may contain information unique to that automobile such as year and make of the car and its maintenance record. The second one or more records 154 may contain information relating to the car loan and how much of the loan has been paid off by the first owner 182.

Other features of the present invention applicable to real property may also be applicable to personal property. For example, the property management server 100 may track the value of the automobile or store photos of the automobile for insurance purposes. Even the target advertising features of the present invention may be applicable to personal property. For example, if the automobile is a compact and there is a sale for a tire that fits compact automobiles, then the corresponding advertisement may be selectively channeled to the automobile owner if the information about the automobile is stored in the system's database 150. Those skilled in the art will recognize that the present invention may be applicable to a wide range of properties other than real property.

A preferred online home management system and method, and many of the attendant advantages thereof, have thus been disclosed. It will be apparent, however, that various changes may be made in the components of the system and arrangement of the steps of the process without departing from the spirit and scope of the invention, the system and method hereinbefore described being merely preferred or exemplary embodiments thereof. For example, the system may be used for more than just property, but may used for managing maintenance of personal property such as automobiles or computers. Therefore, the invention is not to be restricted or limited except in accordance with the following claims and their legal equivalents.

What is claimed is:

1. A property management system, comprising:
a database;
a first one or more data records stored in the database, the first one or more data records for storing data unique to a first property, said data unique to the first property capable of being used for managing the first property;
a second one or more data records in the database, the second one or more data records for storing data unique to a first owner of the first property, said data unique to the first owner capable of being used for the first owner's management of the first property in combination with the data unique to the first property; and
a database management system adapted to parse the first one or more data records for use by a second owner of the first property after the first property is conveyed from the first owner; the database management system further adapted to parse the second one or more data records for retention by the first owner for use by the first owner in a second property.

2. The system of claim 1, wherein the database management system is for integrating the second one or more data records with a third one or more data records after the first owner is conveyed the second property, the third one or more data records for storing data unique to the second property, said data unique to the second property capable of being used for managing the second property in combination with the second one or more data records.

3. The system of claim 1, wherein the database management system is further for populating the first data record by receiving at least a portion of the data unique to the first property from a multiple listing service.

4. The system of claim 3, wherein the database management system is for receiving the at least a portion of the data unique to the first property after the address of the first property is matched with corresponding data in the multiple listing service.

5. The system of claim 4, wherein the database management system is for integrating the second one or more data records with a third one or more data records after the first owner is conveyed the second property, the third one or more data records for storing data unique to the second property, the data unique to the second property capable of being used for managing the second property in combination with the second one or more data records.

6. The system of claim 5, wherein the database management system is further for parsing of the second one or more data records by the second owner of the first property after the first property is conveyed from the first owner.

7. The system of claim 6, wherein the database management system is further for integrating the second one or more data records with the first one or more data records by the second owner after the first property is conveyed from the first owner.

8. The system of claim 5, wherein the database management system is for providing data records from the first and/or the second one or more data records to a third party.

9. The system of claim 8, wherein said third party is a seller's agent.

10. The system of claim 1, wherein the database management system is further for parsing and integrating data records and providing notice to the first owner when a milestone has been reached.

11. The system of claim 1, wherein the database management system is further for monitoring and obtaining data relating to comparative sales data from a multiple listing service and using the data to track home value and equity.

12. The system of claim 1, wherein the database management system is further for monitoring advertisements and parsing and integrating the first and the second one or more data to channel advertisements to the first owner.

13. The system of claim 1, wherein the database management system is further for monitoring the second one or more data records and notifying the first owner when a private mortgage insurance may be cancelled.

14. A method for managing property, comprising:
storing data unique to a first property in a first one or more data records in a database, the data unique to the first property capable of being used for managing the first property;
storing data unique to a first owner of the first property in a second one or more data records in the database, the data unique to the first owner capable of being used for the first owner's management of the first property in combination with the data unique to the first property; and
parsing the first one or more data records for use by a second owner of the first property after the first property is conveyed from the first owner; and
parsing the second one or more data records for retention by the first owner for use by the first owner for managing a second property.

15. The method of claim 14, further comprising the step of integrating the second one or more data records with a third one or more data records after the first owner is conveyed the second property, the third one or more data records for storing data unique to the second property, said data unique to the second property capable of being used for managing the second property in combination with the second one or more data records.

16. The method of claim 14, further comprising the step of populating the first data record by receiving at least a portion of the data unique to the first property from a multiple listing service.

17. The method of claim 16, further comprising the step of receiving the at least a portion of the data unique to the first property after the address of the first property is matched with corresponding data in the multiple listing service.

18. The method of claim 17, further comprising the step of integrating the second one or more data records with a third one or more data records after the first owner is conveyed the second property, the third one or more data records for storing data unique to the second property, said data unique to the second property capable of being used for managing the second property in combination with the second one or more data records.

19. The method of claim 14, further comprising the step of parsing and integrating data records and providing notice to the first owner when a milestone has been reached.

20. The method of claim 14, further comprising the step of monitoring and obtaining data relating to comparative sales data from a multiple listing service and using the data to track home value and equity.

21. The method of claim 14, further comprising the step of monitoring advertisements and parsing and integrating the first one or more data to channel advertisements to the first owner.

22. The method of claim 14, further comprising the step of providing data records from the first one or more data records to a third party.

23. The method of claim 14, wherein said third party is a seller's agent.
